(19) United States
(12) Patent Application Publication
(10) Pub. No.: US 2006/0110128 A1
(43) Pub. Date: May 25, 2006

(54) Image-keyed index for video program stored in personal video recorder

(76) Inventors: Randy R. Dunton, Phoenix, AZ (US); Lawrece A. Booth, Phoenix, AZ (US); Bijan Hakimi, Phoenix, AZ (US)

Correspondence Address: BUCKLEY, MASCHOFF, TALWALKAR LLC, 5 ELM STREET, NEW CANAAN, CT, 06840, US

(21) Appl. No.: 10/997,375

(22) Filed: Nov. 24, 2004

(51) Int. Cl. H04N 5/93

(52) U.S. Cl. 386/52

(57) ABSTRACT

A method includes storing a video program in a storage device. The video program includes a sequence of video signal frames. The method further includes selecting, without user input, key frames from the sequence of video signal frames. The method further includes generating a plurality of index page frames. Each index page frame includes at least one thumbnail image. Each thumbnail image corresponds to a respective one of the selected key frames.

### BACKGROUND

With advances in data storage equipment, so-called personal video recorders (PVRs) are becoming increasingly popular. PVRs may be used by consumers to store on a hard disk or other disk-shaped recording medium (e.g., a DVD-RW—digital video disk-read/write) television programs recorded off-the-air or from cable TV or satellite transmissions. Thus PVRs may be used in place of traditional video cassette recorders (VCRs).

One advantage of PVRs over VCRs is that the recording of video programs on disk in PVRs allows for random access within the recorded programs. However, if a user wishes to view a particular portion of a recorded program rather than the entire program, it still may be inconvenient for the user to find the desired portion of the program. Typically, the only options available are to either (a) fast forward or “rewind” within the program until the desired portion is found and/or (b) enter a time index of a destination frame within the program based on an estimate of where the desired portion is within the program. Either or both options may require considerable effort on the part of the user before the desired portion is found.

### BRIEF DESCRIPTION OF THE DRAWINGS

FIG. 1 is a block diagram of an apparatus according to some embodiments.

FIG. 2 is a block diagram of a PVR that is part of the apparatus of FIG. 1.

FIG. 3 is a block diagram that shows some details of a control device provided in accordance with some embodiments as part of the PVR of FIG. 2.

FIG. 4 is a flow chart that illustrates a process performed in accordance with some embodiments in the PVR of FIG. 2.

FIG. 5 is a pictorial representation of the process of FIG. 4.

FIG. 6 is a flow chart that illustrates another process performed in accordance with some embodiments in the PVR of FIG. 2.

FIG. 7 is a flow chart that illustrates a process performed in accordance with some other embodiments in the PVR of FIG. 2.

FIG. 8 is a pictorial representation of the process of FIG. 7.

FIG. 9 is a flow chart that illustrates another process performed in accordance with some other embodiments in the PVR of FIG. 2.

### DETAILED DESCRIPTION

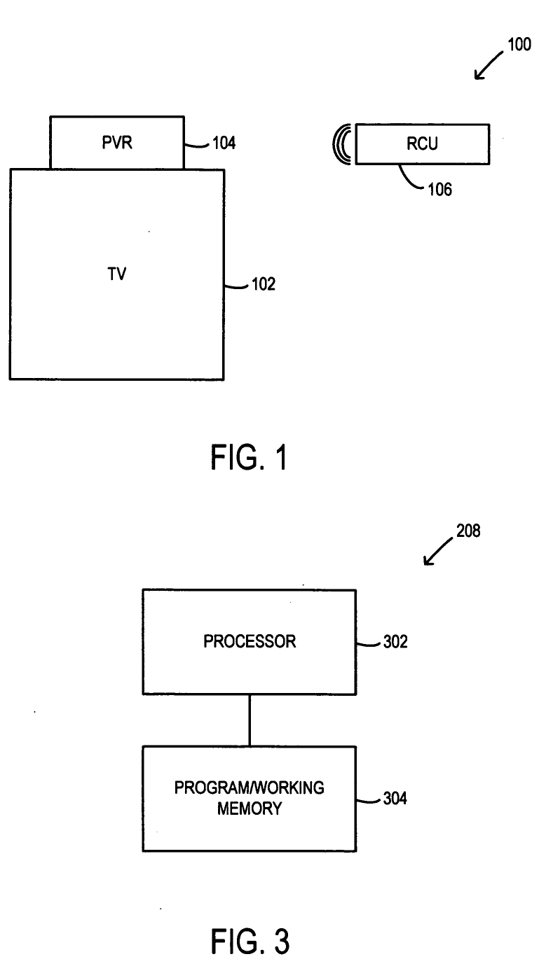

FIG. 1 is a block diagram of an apparatus 100 according to some embodiments. The apparatus 100 includes a television 102, a PVR 104 coupled to the television 102, and a remote control unit 106 to transmit control signals to the PVR 104 in response to the user (not shown) manipulating control keys (not separately shown) on the remote control unit. In some embodiments, the television 102 and the remote control unit 106 may both be conventional items. In some embodiments, the PVR 104 may have features as described below.

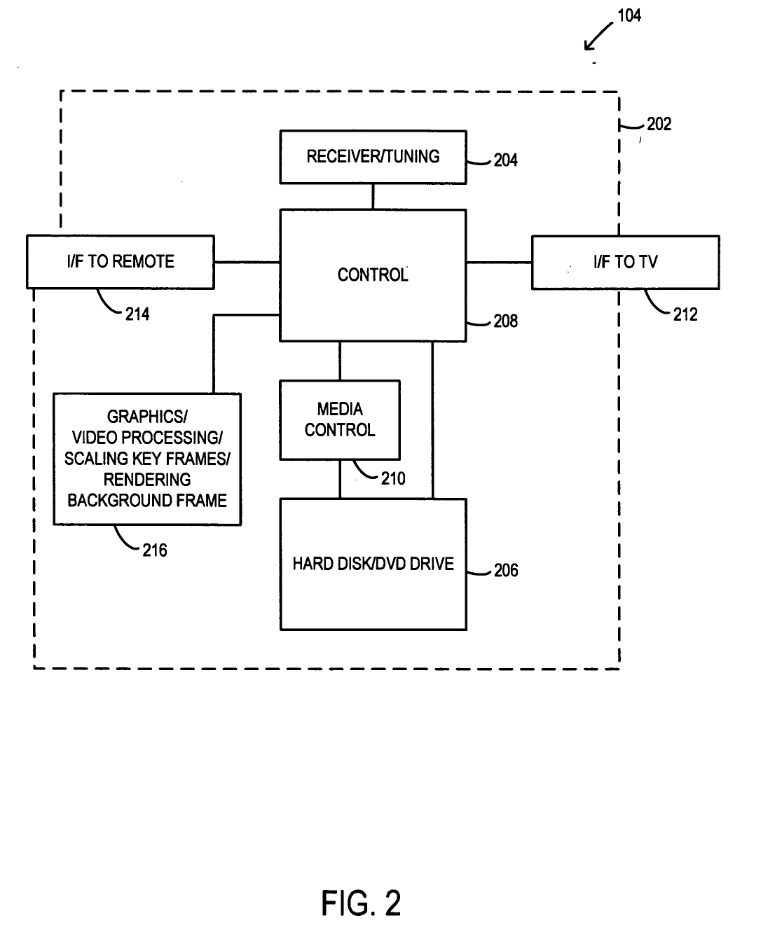

FIG. 2 is a block diagram of the PVR 104 shown in FIG. 1, as provided in accordance with some embodiments. The PVR 104 may include a housing 202 (shown in phantom). The PVR 104 may also include a receiver 204 located in the housing 202. The receiver 204 may include one or more receive units (not separately shown) to allow the receiver 204 to receive one or more of over-the-air TV broadcasts, cable TV transmissions and satellite TV transmissions. The receiver 204 may include one or more antennas and/or connections to such antennas (not separately shown) including antennas for receiving over-the-air TV broadcasts and/or satellite transmission. In addition or alternatively the receiver 204 may include a connection (not separately shown) to a cable (not shown) for receiving cable TV transmissions. Further, the receiver 204 may include one or more tuning circuits (not separately shown) to permit the PVR 104 to be tuned to a particular broadcast, cable or satellite TV channel. In addition or alternatively, the receiver 204 may be configured to receive video programs transmitted over a data network via a protocol such as the Internet Protocol (IP).

The PVR 104 may also include one or more storage devices 206, such as one or more hard disk drives and/or one or more DVD drives located in the housing 202. The storage device(s) 206 may be coupled to the receiver 204 (e.g., via a control device 208 which is also included in the PVR 104 and located in the housing 202). The storage device(s) 206 may be responsive to the receiver 204 to store video programs received by the receiver 204.

FIG. 3 is a block diagram that shows some details of the control device 208 as provided in accordance with some embodiments. As seen from FIG. 3, the control device may be constituted by a processor 302 (e.g., a microprocessor and/or microcontroller and/or digital signal processor) coupled to working and/or program memory 304. In some embodiments, some of the functions of the memory 304, such as control program storage, may be performed at least in part by the storage device(s) 206 (FIG. 2). The memory 304 may store control program instructions that control the processor 302 to perform functions in accordance with some embodiments as described below. In some embodiments, the PVR may be provided in accordance with conventional practices except for some aspects of the control program instructions which control the processor 302.

Referring again to FIG. 2, the PVR 104 may include a media control module 210 that couples the control device 208 to the storage device(s) 206 to allow the control device 208 to control operation of the storage device(s) 206. The media control module 210 may, e.g., control media rotation and/or read/write head positioning with respect to the storage device(s) 206.

The PVR 104 may also include an interface 212 mounted in and/or on the housing 202 to provide for displaying on television 102 (FIG. 1) a video signal reproduced from the storage device(s) 206 or otherwise generated within the PVR 104. Also included in the PVR 104 is an interface 214, mounted in and/or on the housing 202, to receive control signals from the remote control unit 106 (FIG. 1). In addition, the PVR 104 may include a block 216, which may be coupled to and/or integrated with the control device 208, to provide various video processing functions such as graphics generation, scaling of key video frames and/or key video clips, as described below, and/or generation of backgrounds and/or other components of index page frames to be described below.

In some embodiments, at least some of the functions of the video processing block 216 may be incorporated in and/or performed by the control device 208.

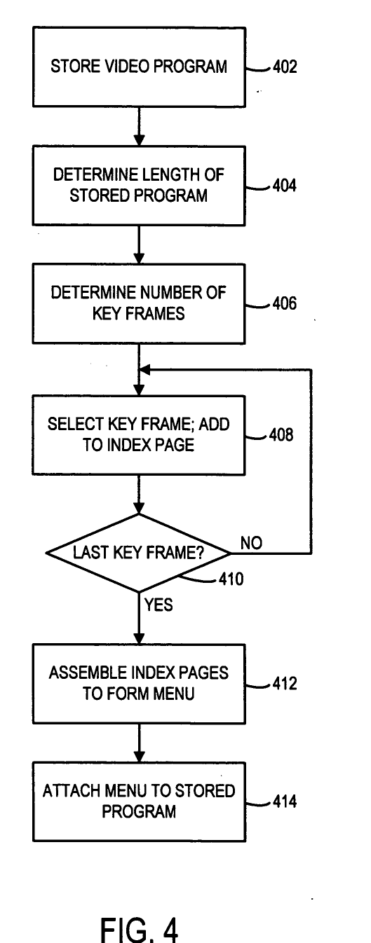

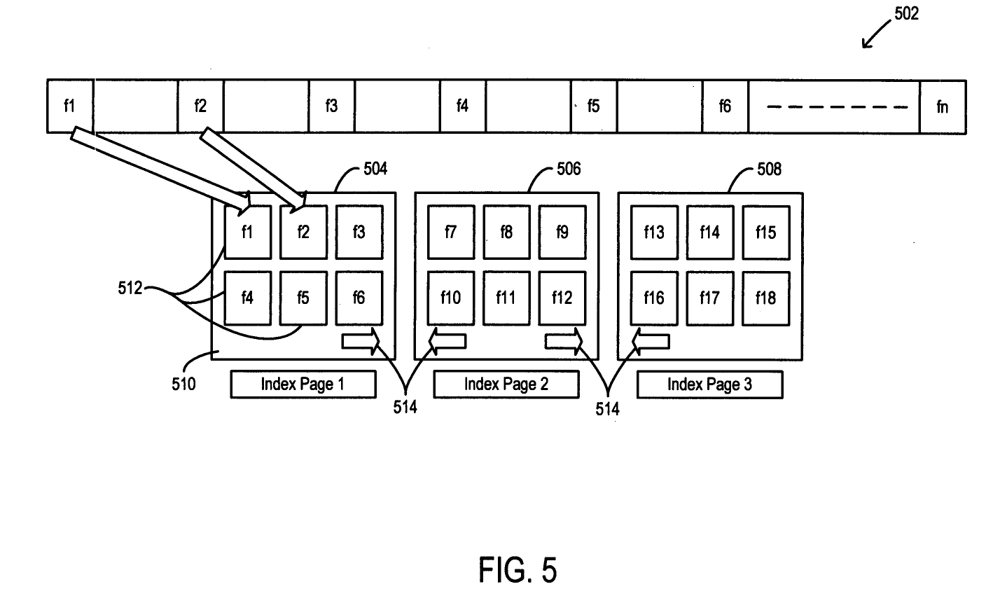

FIG. 4 is a flow chart that illustrates a process performed in accordance with some embodiments in the PVR 104. FIG. 5 schematically depicts aspects of the process.

At 402 in FIG. 4, a video program is stored in the storage device(s) 206. The video program may have been received by the receiver 204 via an over-the-air TV broadcast, via a cable TV transmission, via a satellite TV transmission, or via IP. As used in the appended claims, an over-the-air TV broadcast should be understood to include a satellite TV transmission. The process stage of storing the video program may be considered to include the receiving of the video program. The video program may be a movie, a news program, an episode of a television series, a special program, a sporting event or any other type of programming that may be distributed by cable, broadcast or satellite television, including pay per view or on-demand programming. The recording of the video program may be attended or unattended, and may reflect pre-programming of the PVR to capture a video program transmitted on a later occasion than that on which the user pre-programmed the PVR. The storing of the video program may be performed in a conventional manner.

At 404 in FIG. 4, the PVR 104 (e.g., via control device 208) determines the duration (e.g., the length of viewing time) of the stored video program. Reference numeral 502 in FIG. 5 indicates a depiction of the stored program as a sequence of video signal frames. For example, if the stored video program is a movie received without commercial interruption and having a viewing time of 108 minutes, the duration of the video program is 108 minutes.

At 406 in FIG. 4, the PVR 104 (e.g., the control device 208) determines a number of key frames to be extracted from the stored video program for indexing purposes. In some embodiments, the number of key frames may be determined in accordance with a mathematical formula based on the duration of the stored video program. For example, such a formula may call for the number of key frames to be equal to the duration in minutes, divided by six (with rounding up or down). In the case of the 108 minute movie, for example, this formula would result in a determination that 18 key frames are to be extracted from the stored video program 502.

At 408 in FIG. 4, the PVR 104 (e.g., the control device 208) selects a key frame from among the sequence of video signal frames that makes up the stored video program 502. The selection of the key frame may be performed in a number of different ways. For example, if no prior key frames have been selected, the key frame may be the first video signal frame of the sequence of video signal frames that makes up the stored video program. Alternatively, if no prior key frames have been selected, the key frame may be selected to be at a certain interval (e.g., three minutes) after the start of the video program. In some embodiments, key frames may be selected at substantially equal time intervals throughout the duration of the stored video program. For example, the next key frame may be selected at an interval of, say, six minutes after the previous key frame. To do so, the control device 208 may determine a time code that is exactly six minutes later than the time code of the video signal frame that was selected as the most recent key frame, and then may search to find the closest intrapicture-encoded video signal frame (“I picture”, in MPEG terminology) to that later time code.

In some other embodiments, the selection of the key frame may be based at least in part on the visual contents of the video signal frames. (As used herein and in the appended claims, the content of a video signal frame refers to the nature, or one or more characteristic, of the image represented by the frame.) For example, the selection of the key frame may be based at least in part on results of a scene change detection algorithm. The scene change detection algorithm may be of a type conventionally performed under some circumstances for the purpose of detecting scene changes to aid in video processes such as color correction, noise elimination or resetting of noise filters. In some embodiments, a video signal frame of the sequence of video signal frames that make up the stored video program may be selected to be a key frame if it is (a) determined by the scene change detection algorithm to be the first frame of a new scene and (b) the video signal frame is at least x minutes after the most recent key frame but not more than x+y minutes after the most recent key frame. Where no scene change is found in the time window defined in part (b) of the previous sentence, a key frame may be selected from that time window based on time code alone (or as the closest I picture to a particular time code). In some embodiments, the first video signal frame of each new scene detected by the scene change detection algorithm is selected to be a key frame, unless it is less than z minutes after the most recent key frame.

In some embodiments, an algorithm for selecting key frames may give preference to video signal frames in the stored program that represent certain kinds of images, such as a face or faces.

In some embodiments, the selection of each key frame, or of at least some of the key frames, may be made by the PVR 104 (e.g., by the control device 208) automatically and without any input by a human operator or user. Also, the number of the key frames to be selected may be determined by the PVR 104 (e.g., by the control device 208) automatically and without any input by the user.

In some embodiments, rather than basing the number of key frames to be selected on the total duration of the stored video program, key frames may be selected at certain fixed or variable time intervals along the course of the video program, either during or after recording of the program. As used herein and in the appended claims, “determining a duration” of a video program includes determining either the total duration of the program and/or determining that a certain portion (e.g., a portion which corresponds to a certain fixed time period) of the video program has been recorded and/or reviewed by the control device 208 after recording.

As further indicated at 408 in FIG. 4, each key frame that is selected may be incorporated in an index page frame, such as the index page frames 504, 506, 508 schematically illustrated in FIG. 5. Each of the index page frames may be formed from a frame background 510 generated, e.g., by the video processing block 216 (FIG. 2), and may include one or more thumbnail images 512 arrayed in the frame background 510. Each thumbnail image 512 may correspond to a respective one of the selected key frames (i.e., may represent the same image as a selected key frame, but in a reduced size). (As used herein and in the appended claims, “thumbnail” or “thumbnail image” is used in its commonly understood sense as referring to a reduced image of a graphic or document page used in order to view multiple images on a screen simultaneously. Also, a “thumbnail field” refers to the portion of an image plane in which a thumbnail image is displayed.) The thumbnail images 512 may be arrayed in the frame background 510 in, e.g., a 2 by 3 array (as shown in FIG. 5) or in an array of any other suitable dimensions, including a linear array (i.e., an array in which one dimension is 1). The frame background 510 may also include one or more navigation marks 514 (e.g., arrow marks, as shown in FIG. 5) to allow the user to navigate among index pages. In the case of some index page frames, only one thumbnail image may be included in the index page frame. Where the index page frame includes more than one thumbnail image, it will be appreciated that the index page frame is a composite of two or more of the key frames. The number of thumbnail images included in each index page frame may vary from index page frame to index page frame.

At decision 410 in FIG. 4, it is determined whether the key frame selected at 408 is the last required key frame for the stored video program (i.e., whether the number of key frames that have been selected is equal to the number determined at 406). If not, the process or FIG. 4 loops back to 408 and the next key frame is selected. But if it is determined at 410 that the last key frame has been selected, then the resulting index pages may be assembled, as indicated at 412, to form a navigation menu for the stored video program. Then, as indicated at 414, the navigation menu is attached to the stored video program (e.g., stored in the storage device 206 in association with the stored video program).

In some embodiments, the video program navigation menu made up of the index page frames formed by the process of FIG. 4 may be accessible to the user via a higher level menu. For example, an entry in the higher level menu may indicate the date and time at which the video program was recorded. In other embodiments, the higher level menu may import “metadata” from the stored program to indicate the name of the program, such as the title of a movie or the name of a television series, and may include the date of broadcast of the particular episode recorded. Unlike the conventional image-indexed menus provided with pre-recorded DVDs, the video program navigation menu created by the process of FIG. 4 does not require any human operator to select key images.

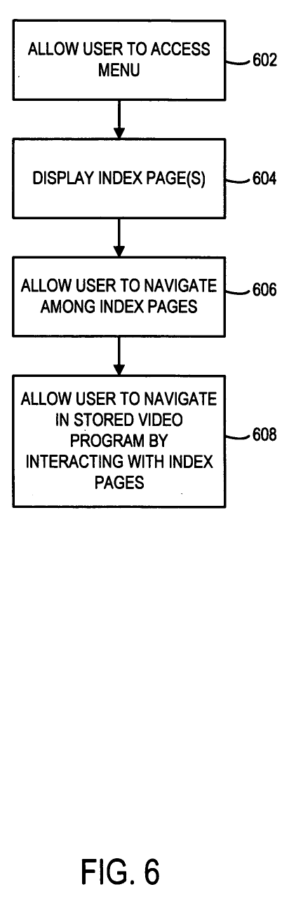

FIG. 6 is a flow chart that illustrates a process performed according to some embodiments by the PVR 104 to permit a user to navigate within a stored video program.

At 602 in FIG. 6, the PVR (e.g., the control device 208) allows the user to access the video program navigation menu created as in the process of FIG. 4. This may occur by the user operating the remote control unit 106 (FIG. 1) to select a menu item from a higher level menu displayed on the TV 102 by the PVR 104. The user's selection of the menu item (and his/her subsequent navigation within the video program navigation menu and within the stored video program, as described below) may be accomplished by actuation of certain control keys (not separately shown) on the remote control unit. Such control keys may, for example, include conventional direction arrow keys (indicating, e.g., left, right, up, down) and a “select” or “enter” key. The higher level menu (or a still higher level menu from which it is reached) may be displayed on the TV 102 by the PVR 104 in response to the user actuating a dedicated control key such as a “menu” key on the remote control unit 106.

In response to the user selecting from the higher level menu a menu item that corresponds to a particular video program that has been stored in the PVR 104, the PVR 104 may cause the TV 102 to display, e.g., the first index page frame that was previously created (by the process of FIG. 4) for the stored video program in question. (Displaying of at least one of the index page frames is indicated at 604 in FIG. 6.) The user is then allowed, as indicated at 606 in FIG. 6, to navigate among the index page frames which make up the video program navigation menu. For example, the user may navigate to another index page frame by interacting with a navigation mark 514 (FIG. 5) that is included as part of the currently displayed index page frame. As used herein and in the appended claims, “interacting” with a displayed image frame or a portion thereof may include moving a cursor within a displayed image and/or positioning the cursor at or on or near a portion of the image and/or indicating selection of a menu option represented by a portion of a displayed image. The movement of a cursor may be accomplished by actuation of directional arrow keys, as referred to above, on the remote control unit, and selection of a particular menu option may be accomplished by actuation of a “select” or “enter” control key.

More specifically, in some embodiments the user may use one or more arrow keys on the remote control unit 106 to move a cursor (not shown) to a navigation mark 514 that is part of an index page (e.g., 504, 506 or 508) that is currently being displayed, and then may indicate “selection” of the navigation mark (by actuating a “select” key, e.g., on the remote control unit 106) to cause another one of the index pages to be displayed. In this way, for example, navigation among index pages may be accomplished. (It will be appreciated that at least in some embodiments at most one of the index pages may be displayed by the TV 102 at any given time.)

Further, as indicated at 608 in FIG. 6, the PVR 104 (e.g., the control device 208) may operate to allow the user to navigate in the stored video program by interacting with the index pages, and more specifically by interacting with the key frame thumbnail images 512 that are part of the index pages. In particular, the user may be permitted to select a particular frame in the stored video program from which reproduction of the video program is to proceed by selecting the corresponding thumbnail image 512 from a currently displayed index page. Selection of a thumbnail image may, in some embodiments, be accomplished by using one or more of the aforementioned arrow keys to move the cursor to the desired thumbnail image 512 and then actuating a “select” key on the remote control unit. The user may do so because the user recognizes that the portion of the stored video program which the user wishes to see is represented by the thumbnail image in question. In response to such activity on the part of the user, the PVR may reproduce the stored video program via the TV, starting with the key frame to which the selected thumbnail image corresponds. From the foregoing it will be understood that “navigating” within the stored video program refers to selecting a particular portion of the video program to be currently reproduced and displayed.

If, while the stored video program is being reproduced, the user wishes to navigate to another portion of the video program, he/she may do so, in some embodiments, by invoking a menu function, and then navigating through one or more menu screens to the video program navigation menu formed by the index page frames described above. Once more the user may, if desired, navigate among the index pages, and may select another portion of the video program to be reproduced and displayed by selecting a corresponding one of the thumbnail images.

With the processes described above with reference to FIGS. 4-6, the PVR may automatically provide an intuitive and easy-to-use interface by which the user can conveniently navigate within a stored video program. In at least some embodiments, no user input or other human input is required after or during recording of the video program to create the index pages which facilitate the navigation within the stored video program.

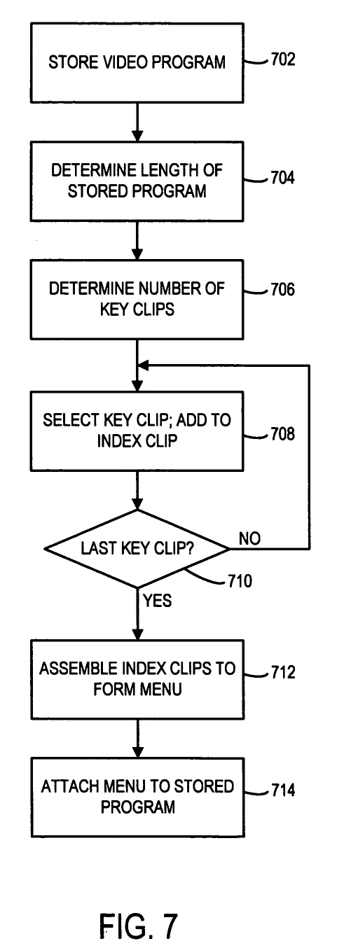

In some other embodiments, a video program navigation menu may be provided which makes it even easier for a user to find and select for reproduction a desired portion of a video program stored in a PVR. Such other embodiments will now be described with reference to FIGS. 7-9, and may be implemented, in at least some embodiments, with hardware like that described with reference to FIGS. 1-3.

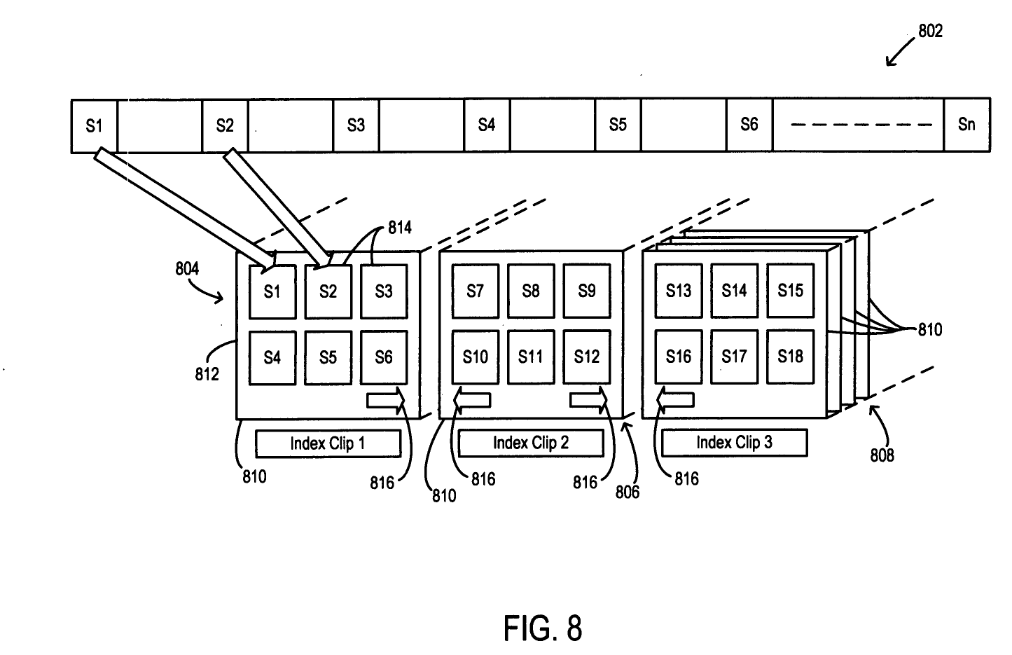

FIG. 7 is a flow chart that illustrates a process performed in accordance with some embodiments in the PVR 104. FIG. 8 schematically depicts aspects of the process.

At 702 in FIG. 7, a video program is stored in the storage device(s) 206. The video program may have been received by the receiver 204 via an over-the-air TV broadcast, via a cable TV transmission, via a satellite TV transmission, or via IP. The process stage of storing the video program may be considered to include the receiving of the video program. The video program may be a movie, a news program, an episode of a television series, a special program, a sporting event or any other type of programming that may be distributed by cable, broadcast or satellite television, including pay per view or on-demand programming. The recording of the video program may be attended or unattended, and may reflect pre-programming of the PVR to capture a video program transmitted on a later occasion than that on which the user pre-programmed the PVR. The storing of the video program may be performed in a conventional manner.

At 704 in FIG. 7, the PVR 104 (e.g., via control device 208) determines the duration (e.g., the length of viewing time) of the stored video program. Reference numeral 802 in FIG. 8 indicates a depiction of the stored program as a sequence of video signal frames. For example, if the stored program is a movie received without commercial interruption and having a viewing time of 108 minutes, the duration of the video program is 108 minutes.

At 702 in FIG. 7, the PVR 104 (e.g., the control device 208) determines a number of key video clips to be extracted from the stored video program for indexing purposes. In some embodiments, the number of key video clips may be determined in accordance with a mathematical formula based on the duration of the stored video program. For example, such a formula may call for the number of key video clips to be equal to the duration in minutes, divided by six (rounded up or down). In the case of the 108 minute movie, for example, this formula would result in a determination that 18 key video clips are to be extracted from the stored video program 802.

At 708 in FIG. 4, the PVR 104 (e.g., the control device 208) selects a first frame (e.g., frame “S1” shown in FIG. 8) of a key video clip. The first frame is selected from among the sequence of video signal frames that makes up the stored video program 802. The selection of the first frame of the key video clip may be performed in a number of different ways. For example, if no prior video clips have been selected, the first frame of the video clip to be selected may be the first video signal frame of the sequence of video signal frames that makes up the stored video program. Alternatively, if no prior key video clips have been selected, the first frame of the video clip to be selected may be selected to be at a certain interval (e.g., three minutes) after the start of the video program. In some embodiments, key video clips may be selected at substantially equal time intervals throughout the duration of the stored video program. For example, the next key video clip may be selected at an interval of, say, six minutes after the previous key video clip. To do so, the control device 208 may determine a time code that is exactly six minutes later than the time code of the first frame of the most recent key video clip, and then may search to find the closest I picture frame to that later time code.

In some other embodiments, the selection of key video clips may be based at least in part on the visual content of the video signal frames. For example, the selection of the key video clips may be based at least in part on results of a scene change detection algorithm. The scene change detection algorithm may be of a type conventionally performed under some circumstances for the purpose of detecting scene changes to aid in video processes such as color correction, noise elimination or resetting of filters. In some embodiments, a video signal frame of the sequence of video signal frames that make up the stored video program may be selected to be the first frame of a key video clip if the video signal frame is (a) determined by the scene change detection algorithm to be the first frame of a new scene and (b) the video signal frame is at least x minutes after the most recent key video clip but not more than x+y minutes after the most recent key video clip. Where no scene change is found in the time window defined in part (b) of the previous sentence, the first frame of the next key video clip may be selected from that time window based on time code alone (or as the closest I picture to a particular time code). In some embodiments, the first video signal frame of each new scene detected by the scene change detection algorithm is selected to be the first frame of a key video clip, unless the first video signal frame of the new scene is less than z minutes after the most recent key video clip.

In some embodiments, an algorithm for selecting the first frames of key video clips may give preference to video signal frames in the stored program that represent certain kinds of images, such as a face or faces.

In some embodiments, the selection of each key video clip, or of at least some of the key video clips, may be made by the PVR 104 (e.g., by the control device 208) automatically and without any input by a human operator or user. Also, the number of key video clips to be selected may be determined by the PVR 104 (e.g., by the control device 208) automatically and without any input by the user.

It will be understood that “key video clip” may refer to a broken or unbroken sequence of video frames taken from a stored video program to serve as an index to the video program. The clip may be played back as a moving picture (e.g., in a thumbnail field in an index page frame) to allow a user to identify a portion of the video program which the user desires to select for reproduction and display. The clip may be considered to be a subsequence of the sequence of video signal frames which make up the stored video program.

In some embodiments, rather than basing the number of key video clips to be selected on the total duration of the stored video program, key video clips may be selected at certain fixed or variable intervals along the course of the video program, either during or after recording of the program.

As further indicated at 708 in FIG. 7, each key video clip that is selected may be used to compose an index video clip, such as index video clips 804, 806, 808 schematically illustrated in FIG. 8. Each index video clip is formed of a sequence of index video frames 810 (to simplify the drawing, only the first index video frame of index video clips 804, 806 is shown in FIG. 8). In some embodiments, all the index video clips may be of the same time duration, say about 10 seconds, with the duration of the index video clips being the same as the duration of the key video clips from which the index video clips are composed.

Each of the index video frames 810 may be formed from a frame background 812 which does not change from index video frame to index video frame within a given index video clip. Each frame background may surround a certain number (one or more) of thumbnail fields 814 arrayed in the frame background 812. Each thumbnail field may have displayed therein a respective thumbnail image that corresponds to a frame from a respective one of the key video clips selected at 708 (FIG. 7). As will be seen, a respective one of the key video clips is displayed as a moving picture within each of the thumbnail fields of an index video clip, as the index video clip is reproduced.

The thumbnail fields 814 may be arrayed in the frame background 812 in, e.g., a 2 by 3 array (as shown in FIG. 8) or in an array of any other suitable dimensions, including a linear array (i.e., an array in which one dimension is 1). In the case of each index video clip that has more than one thumbnail field 814, the index video clip is a composite of two or more key video clips, each reproduced as a moving picture within the background frame 812. Consequently, in each index video clip having two or more thumbnail fields, at least some of the index video frames may be composites of two or more video frames, with each of such video frames being from a respective one of the key video clips.

The key video clips may all be de-compressed before being scaled and then used to compose index video clips, and then the index video clips, in turn, may be compression-encoded.

The frame background 812 may include one or more navigation marks 816 (e.g., arrow marks, as shown in FIG. 8) to allow the user to navigate among the index video clips. The number of thumbnail fields included in each index video clip may vary from index video clip to index video clip.

At decision 710 in FIG. 7, it is determined whether the key video clip selected at 708 is the last required key video clip for the stored video program (i.e., whether the number of key video clips that have been selected is equal to the number determined at 706). If not, the process of FIG. 7 loops back to 708 and the next key video clip is selected. But if it is determined at 410 that the last key video clip has been selected, then the resulting index video clips may be assembled, as indicated at 712, to form a moving image navigation menu for the stored video program. Then, as indicated at 714, the navigation menu is attached to the stored video program (e.g., stored in the storage device 206 in association with the stored video program).

In some embodiments, the video program navigation menu made up of the index video clips formed by the process of FIG. 7 may be accessible to the user via a higher level menu. For example, an entry in the higher level menu may indicate the date and time at which the video program was recorded. In other embodiments, the higher level menu may import “metadata” from the stored program to indicate the name of the program, such as the title of a movie or the name of a television series, and also may include the date of broadcast of the particular episode recorded.

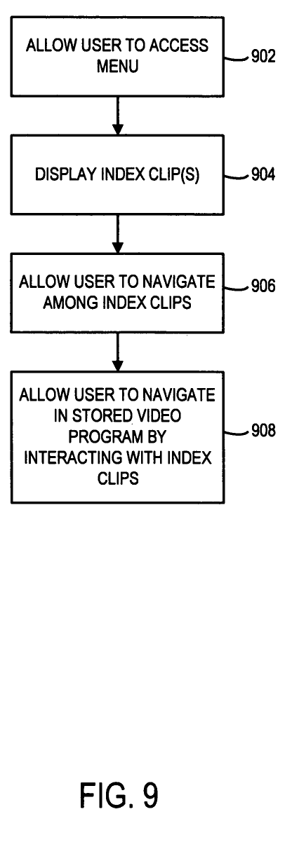

FIG. 9 is a flow chart that illustrates a process performed according to some embodiments by the PVR 104 to permit a user to navigate within a stored video program.

At 902 in FIG. 9, the PVR (e.g., the control device 208) allows the user to access the video program navigation menu created as in the process of FIG. 7. This may occur by the user operating the remote control unit 106 (FIG. 1) to select a menu item from a higher level menu displayed on the TV 102 by the PVR 104. The user's selection of the menu item (and his/her subsequent navigation within the video program navigation menu and within the stored video program, as described below) may be accomplished by actuation of certain control keys on the remote control unit. Such control keys may, for example, include conventional direction arrow keys and a “select” or “enter” key. The higher level menu (or a still higher level menu from which it is reached) may be displayed on the TV 102 by the PVR 104 in response to the user actuating a dedicated control key such as a “menu” key on the remote control unit 106.

In response to the user selecting from the higher level menu a menu item that corresponds to a particular video program that has been stored in the PVR 104, the PVR 104 may cause the TV 102 to display, e.g., the first index video clip that was previously created (by the process of FIG. 7) for the stored video program in question. (Displaying of at least one of the index video clips is indicated at 904 in FIG. 9.) When an index video clip is displayed, it is reproduced as a composite moving video image, with a respective one of the key video clips being displayed as a thumbnail moving video image within each thumbnail field of the index video clip. Each of the key video clips may run repeatedly in a loop within the respective thumbnail field.

The user is then allowed, as indicated at 906 in FIG. 9, to navigate among the index video clips which make up the video program navigation menu. For example, the user may navigate to another index video clip by interacting with a navigation mark 816 (FIG. 8) that is included as part of the currently displayed index video clip. More specifically, in some embodiments the user may use one or more arrow keys on the remote control unit 106 to move a cursor (not shown) to a navigation mark 816 that is part of an index video clip (e.g., 804, 806, 808) that is currently being displayed, and then may indicate “selection” of the navigation mark (by actuating a “select” key, e.g., on the remote control unit 106) to cause another one of the index video clips to be displayed. In this way, for example, navigation among index video clips may be accomplished. (It will be appreciated that at least in some embodiments at most one index video clip may be displayed on the TV 102 at any given time.)

Further, as indicated at 908 in FIG. 9, the PVR 104 (e.g., the control device 208) may operate to allow the user to navigate in the stored video program by interacting with the index video clips, and more specifically by interacting with the thumbnail fields that are included in the index video clips. In particular, the user may be permitted to select a particular frame in the stored video program from which reproduction of the video program is to proceed. The selection of the particular frame may be accomplished by selecting one of the key video clips (or more precisely by selecting the corresponding thumbnail field) in the currently displayed index video clip. Selection of a thumbnail field may, in some embodiments, be accomplished by using one or more of the aforementioned arrow keys to move the cursor to the desired thumbnail field and then actuating a “select” key on the remote control unit. The user may do so because the user recognizes that the portion of the stored video program which the user wishes to see is represented by the key video clip playing in the thumbnail field in question. In response to such activity on the part of the user, the PVR may reproduce the stored video program via the TV, starting for example with the first frame of the index video clip that was playing in the thumbnail field selected by the user from the currently displayed index video clip.

If, while the stored program is being reproduced, the user wishes to navigate to another portion of the video program, he/she may do so, in some embodiments, by invoking a menu function, and then navigating through one or more menu screens to the video program navigation menu formed by the index video clips described above. Once more the user may, if desired, navigate among the index video clips, and may select another portion of the video program to be reproduced and displayed by selecting a thumbnail field which is showing a key video clip that corresponds to the desired portion of the program.

With the processes described above with reference to FIGS. 7-9, the PVR may provide a user interface that is even more user-friendly than that described with reference to FIGS. 4-6. The presentation of key video clips to index the video program may make it even easier for the user to recognize and select portions of the stored video program that the user is interested in viewing. Moreover, at least in some embodiments, no user input or other human input may be needed after or during recording of the video program to create the video-clip-based indexing which facilitates the user's navigation within the stored video program.

The flow diagrams and descriptions thereof included herein are not intended to imply a fixed order for performing the process stages, and the process stages may be performed in any order that is practicable.

The indexing and navigation features described herein may be embodied in other video storage devices besides PVRs. Moreover, these features may be embodied in electronic equipment in which video recording functions are incorporated or embedded, including televisions with integrated video recorders, media centers that include video recording functions, personal computers, etc.

The several embodiments described herein are solely for the purpose of illustration. The various features described herein need not all be used together, and any one or more of those features may be incorporated in a single embodiment. Therefore, persons skilled in the art will recognize from this description that other embodiments may be practiced with various modifications and alterations.

What is claimed is:

1. A method comprising:
storing a video program in a storage device, the video program including a sequence of video signal frames;
selecting, without user input, key frames from said sequence of video signal frames; and
generating a plurality of index page frames, each index page frame including at least one thumbnail image, each thumbnail image corresponding to a respective one of said selected key frames.

2. The method of claim 1, further comprising:
determining a duration of the stored video program; and
determining, based on the determined duration, a number of key frames;
wherein said selected key frames are equal in number to said determined number of key frames.

3. The method of claim 2, wherein said determining the number of key frames is performed without user input.

4. The method of claim 1, further comprising:
displaying at least some of said plurality of index page frames.

5. The method of claim 4, further comprising:
allowing a user to navigate within said stored video program by interacting with said displayed at least some index page frames.

6. The method of claim 4, further comprising:
allowing a user to navigate among the index page frames.

7. The method of claim 1, wherein said selecting is based at least in part on contents of said video signal frames.

8. The method of claim 1, wherein said selecting is based at least in part on a scene change detection algorithm.

9. The method of claim 1, wherein the storing includes receiving the video program via a cable TV transmission.

10. The method of claim 1, wherein the storing includes receiving the video program via an over-the-air TV broadcast.

11. The method of claim 1, wherein the storing includes receiving the video program via Internet Protocol.

12. The method of claim 1, wherein each of the selected key frames is an intrapicture encoded frame from the sequence of video signal frames.

13. The method of claim 1, wherein at least one of the index page frames includes a respective plurality of thumbnail images, each of said thumbnail images corresponding to a respective one of said selected key frames.

14. An apparatus comprising:
a housing;
a receiver located in the housing to receive a video program, the video program including a sequence of video signal frames;
a storage device, located in the housing and responsive to the receiver, to store the received video program; and
a control device, coupled to the storage device, and operative to:
select key frames from said sequence of video signal frames;
generate a plurality of index page frames, each index page frame including at least one thumbnail image, each thumbnail image corresponding to a respective one of said selected key frames; and
store the index page frames in said storage device.

15. The apparatus of claim 14, wherein said control device is further operative to:
determine a duration of the stored video program; and
determine, based on the determined duration, a number of key frames;
and wherein said selected key frames are equal in number to said determined number of key frames.

16. The apparatus of claim 15, wherein said control device is operative to determine the number of key frames without user input.

17. The apparatus of claim 14, wherein said control device is operative to select said key frames without user input.

18. The apparatus of claim 14, further comprising:
a television coupled to the storage device to display at least some of the index page frames.

19. The apparatus of claim 18, further comprising:
a remote control unit to transmit control signals to control said control device to allow a user to navigate within said stored video program by interacting with said displayed at least some index page frames.

20. The apparatus of claim 18, further comprising:
a remote control unit to transmit control signals to control said control device to allow a user to navigate among the index page frames.

21. The apparatus of claim 14, wherein the control device selects said key frames based at least in part on a scene change detection algorithm.

22. The apparatus of claim 14, wherein the receiver receives the video program from a cable TV transmission.

23. The apparatus of claim 14, wherein the receiver receives the video program from an over-the-air broadcast.

24. The apparatus of claim 14, wherein the receiver receives the video program via Internet Protocol.

25. The apparatus of claim 14, wherein at least one of the index page frames includes a respective plurality of thumbnail images, each of said thumbnail images corresponding to a respective one of said selected key frames.

26. An apparatus comprising:
a storage medium having stored thereon instructions that when executed by a machine result in the following:
storing a video program in a storage device, the video program including a sequence of video signal frames;
selecting, without user input, key frames from said sequence of video signal frames; and
generating a plurality of index page frames, each index page frame including at least one thumbnail image, each thumbnail image corresponding to a respective one of said selected key frames.

27. The apparatus of claim 26, wherein said instructions when executed by the machine further result in:
determining a duration of the stored video program; and
determining, based on the determined duration, a number of key frames;
wherein said selected key frames are equal in number to said determined number of key frames.

28. The apparatus of claim 27, wherein said determining the number of key frames is performed without user input.

29. The apparatus of claim 26, wherein said instructions when executed by the machine further result in:
displaying at least some of said plurality of index page frames.

30. A method comprising:
storing a video program in a storage device, the video program including a sequence of video signal frames;
selecting key video clips from said sequence of video signal frames, each of said key video clips including a subsequence of said video signal frames, each of said subsequences including a respective plurality of said video signal frames; and
generating a plurality of index video clips, each of said index video clips including a plurality of index video frames, at least one of said index video clips being a composite of at least two of said key video clips arrayed in a frame background.

31. The method of claim 30, further comprising:
determining a duration of the stored video program;
determining, based on the determined duration, a number of key video clips;
wherein said selected video clips are equal in number to said determined number of key video clips.

32. The method of claim 31, wherein said determining the number of key video clips is performed without user input.

33. The method of claim 30, wherein:
in each of said at least one of said index video clips, said key video clips arrayed in said frame background are each in a respective thumbnail field within said frame background.

34. The method of claim 33, further comprising:
displaying at least some of said plurality of index video clips.

35. The method of claim 33, further comprising:
allowing a user to navigate within said stored video program by interacting with said thumbnail fields in said displayed at least some index video clips.

36. The method of claim 30, wherein said selecting is based at least in part on contents of said video signal frames.

37. The method of claim 30, wherein said selecting is based at least in part on a scene change detection algorithm.

38. The method of claim 30, wherein the storing includes receiving the video program via a cable TV transmission.

39. The method of claim 30, wherein the storing includes receiving the video program via an over-the-air TV broadcast.

40. The method of claim 30, wherein the storing includes receiving the video program via Internet Protocol.

41. An apparatus comprising:
a housing;
a receiver located in the housing to receive a video program, the video program including a sequence of video signal frames;
a storage device, located in the housing and responsive to the receiver, to store the received video program; and
a control device, coupled to the storage device, and operative to:
select key video clips from said sequence of video signal frames, each of said key video clips including a subsequence of said video signal frames, each of said subsequences including a respective plurality of said video signal frames; and
generate a plurality of index video clips, each of said index video clips including a plurality of index video frames, at least one of said index video clips being a composite of at least two of said key video clips arrayed in a frame background.

42. The apparatus of claim 41, wherein said control device is further operative to:
determine a duration of the stored video program; and
determine, based on the determined duration, a number of key video clips;
wherein said selected key video clips are equal in number to said determined number of key video clips.

43. The apparatus of claim 42, wherein said control device is operative to determine the number of key video clips without user input.

44. The apparatus of claim 41, wherein said control device is operative to select said key video clips without user input.

45. The apparatus of claim 41, further comprising:
a television coupled to the storage device to display at least some of the index video clips.

46. The apparatus of claim 45, wherein:
in each of said at least one of said index video clips, said key video clips arrayed in said frame background are each in a respective thumbnail field within said frame background.

47. The apparatus of claim 46, further comprising:
a remote control unit to transmit control signals to control said control device to allow a user to navigate within said stored video program by interacting with said thumbnail fields in said displayed at least some index video clips.

48. The apparatus of claim 45, further comprising:
a remote control unit to transmit control signals to control said control device to allow a user to navigate among the index video clips.

49. The apparatus of claim 41, wherein the control device selects said key video clips based at least in part on a scene change detection algorithm.

50. The apparatus of claim 41, wherein the receiver receives the video program from a cable TV transmission.

51. The apparatus of claim 41, wherein the receiver receives the video program from an over-the-air broadcast.

52. The apparatus of claim 41, wherein the receiver receives the video program via Internet Protocol.

53. An apparatus comprising:
a storage medium having stored thereon instructions that when executed by a machine result in the following:
storing a video program in a storage device, the video program including a sequence of video signal frames;
selecting key video clips from said sequence of video signal frames, each of said key video clips including a subsequence of said video signal frames, each of said subsequences including a respective plurality of said video signal frames; and
generating a plurality of index video clips, each of said index video clips including a plurality of index video frames, at least one of said index video clips being a composite of at least two of said key video clips arrayed in a frame background.

54. The apparatus of claim 53, wherein said instructions when executed by the machine further result in:
determining a duration of the stored video program; and
determining, based on the determined duration, a number of key video clips;
wherein said selected key video clips are equal in number to said determined number of key video clips.

55. The apparatus of claim 53, wherein:
in each of said at least one of said index video clips, said key video clips arrayed in said frame background are each in a respective thumbnail field within said frame background.

56. The apparatus of claim 53, wherein said instructions when executed by the machine further result in:
displaying at least some of said plurality of index video clips.

57. The apparatus of claim 53, wherein said instructions when executed by the machine further result in:
allowing a user to navigate within said stored video program by interacting with said thumbnail fields in said displayed at least some index video clips.
